(19) United States
(12) Patent Application Publication
(10) Pub. No.: US 2016/0195404 A1
(43) Pub. Date: Jul. 7, 2016

(54) PEER TO PEER CAR SHARING SOCIAL-GRAPH CONFIGURATOR

(71) Applicant: FORD GLOBAL TECHNOLOGIES, LLC, Dearborn, MI (US)

(72) Inventors: Krishnaswamy Venkatesh PRASAD, Ann Arbor, MI (US); Bryan Roger GOODMAN, Northville, MI (US); Eric H. WINGFIELD, Ann Arbor, MI (US); Michael James WHITENS, Milford, MI (US)

(21) Appl. No.: 14/589,749

(22) Filed: Jan. 5, 2015

(51) Int. Cl. G01C 21/34; G06T 11/20

(52) U.S. Cl. CPC G01C 21/3438; G06T 11/206

(57) ABSTRACT

A server comprising a transceiver configured to communicate data with a remote vehicle computer system and a car-reservation system. The server further includes a processor configured to utilize the data to output a car-sharing social-graph, the car-sharing social-graph including a vehicle for sharing, a vehicle-location, a user-location, and a potential parking-spot for sharing the vehicle.

### TECHNICAL FIELD

The illustrative embodiments generally relate to utilizing a vehicle computer system for generating a social-graph.

### BACKGROUND

U.S. Patent Publication No. 2011/0112969 to Zaid et al. discloses a vehicle access control. In various embodiments, a vehicle reservation from a wireless communication device is received, the vehicle reservation is authenticated, and access to the vehicle is provided after authenticating the vehicle reservation. In various embodiments, a system for vehicle access control includes a vehicle access control component that is configured to provide access to a vehicle and a communication interface for communication with a wireless communication device, a communication interface for communication with a wireless communication device. Access to the vehicle is provided when a vehicle reservation is received from the wireless communication device.

U.S. Patent Publication No. 2014/0129135 to Holden et al. disclose a system and method for providing position information of a transit object to a computing device is provided. Global positioning satellite (GPS) information of a transit object can be periodically received. For each of some of the GPS information, one or more candidate points of a transit system can be identified based on the GPS information. Using the one or more candidate points, a most likely path of travel can be determined. Additional position points along the most likely path of travel can be extrapolated and transmitted to a computing device.

### SUMMARY

A first illustrative embodiment discloses a server comprising a transceiver configured to communicate data with a remote vehicle computer system and a car-reservation system. The server further includes a processor configured to utilize the data to output a car-sharing social-graph, the car-sharing social-graph including a vehicle for sharing, a vehicle-location, a user-location, and a potential parking-spot for sharing the vehicle.

A second illustrative embodiment discloses a vehicle computer system, comprising a transceiver configured to communicate data with a remote server including vehicle data, vehicle reservation data, and social-graph data from the remote server related to the vehicle and the vehicle reservation. The vehicle computer system also includes a processor configured to utilize the data to authenticate a user and a vehicle after authenticating the vehicle reservation.

A third illustrative embodiment discloses a method for car sharing, comprising communicating data with a remote vehicle computer system and a car-reservation system. The method for car sharing further includes outputting a car-sharing social-graph, the car-sharing social-graph including graphical output depicting a vehicle for sharing, a vehicle-location, a user-location, and a potential parking-spot for sharing the vehicle.

### BRIEF DESCRIPTION OF THE DRAWINGS

FIG. 1 illustrates an example block topology for a vehicle based computing system;

FIG. 2 illustrates an example block topology for vehicle sharing between peers;

FIG. 3 illustrates an example block topology of an off-board server utilizing various data for peer-to-peer car sharing;

FIG. 4 illustrates an example of peer-to-peer car-sharing social-graph; and

FIG. 5 illustrates an example of the peer-to-peer car sharing architecture.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

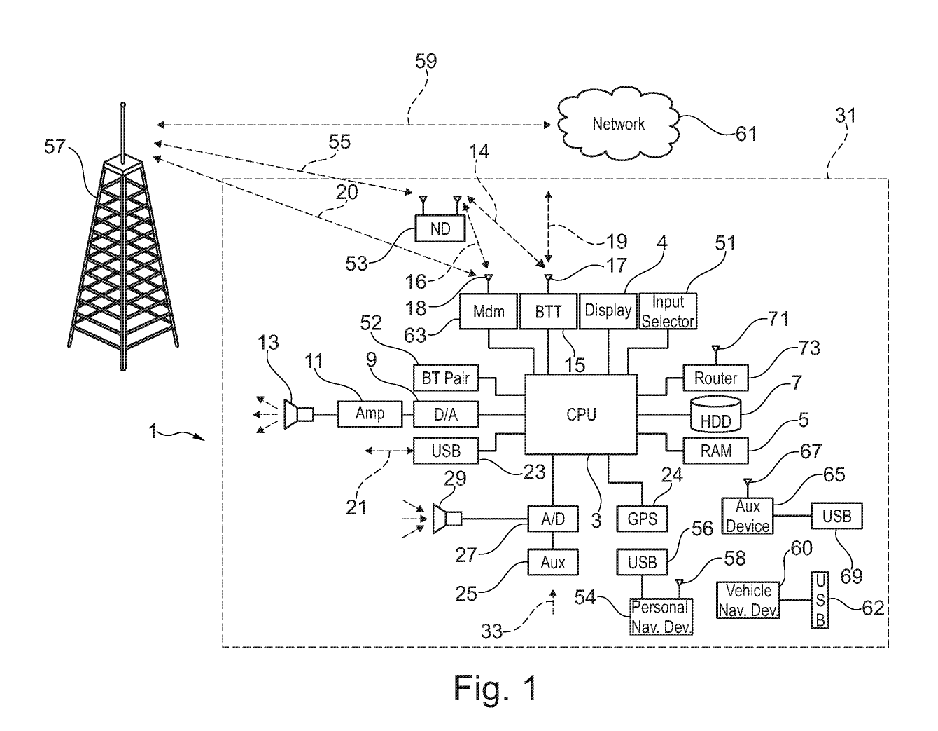

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, at least one processor 3 controls at least some portion of the operation of the vehicle-based computing system 31. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. Non-transitory memory may include both persistent memory and RAM. In general, persistent memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, a screen 4, which may be a touchscreen display, and a BLUETOOTH input 15 are all provided. An input selector 51 is also provided, to allow a user to swap between various inputs. Input from both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus, a LIN bus, a MOST bus, an Ethernet bus, or a FlexRay bus) to pass data to and from the VCS (or components thereof).

Outputs from the processor 3 may include, but are not limited to, a visual display 4 and a speaker 13 or stereo system output. The speaker is connected to an amplifier 11 and receives its signal from the processor 3 through a digital-to-analog converter 9. Outputs can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Other wireless communication means that can be used in this realm is free-space optical communication (such as IrDA) and non-standardized consumer IR protocols or inductive coupled means including but not limited to near-field communications systems such as RFID.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Division Multiple Access (CDMA), Time Division Multiple Access (TDMA), Space-Division Multiple Access (SDMA) for digital cellular communication, including but not limited to Orthogonal Frequency-Division Multiple Access (OFDMA) which may include time-domain statistical multiplexing. These are all ITU IMT-2000 (3 G) compliant standards and offer data rates up to 2 Mbps for stationary or walking users and 385 Kbps for users in a moving vehicle. 3 G standards are now being replaced by IMT-Advanced (4 G) which offers 100 Mbps for users in a vehicle and 1 Gbps for stationary users. If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply particular VACS to a given solution. In all solutions, it is contemplated that at least the vehicle computing system (VCS) located within the vehicle itself is capable of performing the exemplary processes. Additionally, the VACS may include an after-market or auxiliary device that may plug-in to a OBDII port (or USB port, etc) to communicate with the vehicle-bus.

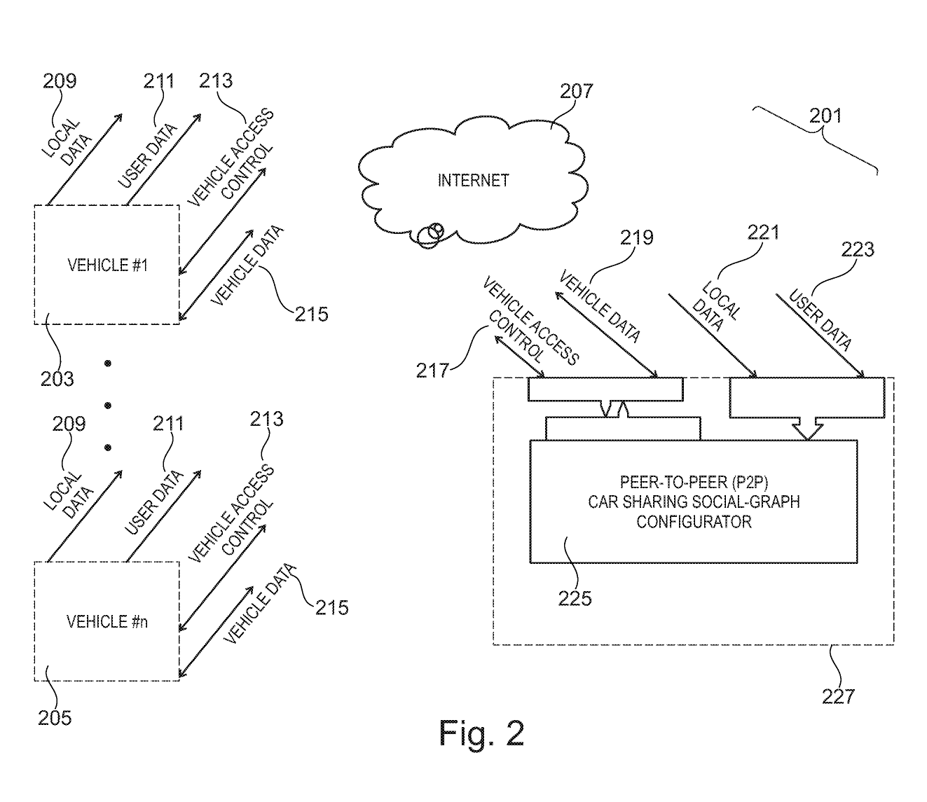

FIG. 2 illustrates an example of a block topology for vehicle sharing between peers. The vehicle sharing system 201 may be utilized for sharing a vehicle between peers within a definite community. The community may include a definite set of rules for vehicle sharing. A vehicle 203 may be enabled for vehicle sharing. A vehicle may be shared by utilizing a user's own automobile or a rented vehicle. The car sharing systems may provide users or members with access to a vehicle for short-term hourly/daily use, as well as long-term usage. The vehicles owned by a car sharing provider may be distributed through a network of locations. The users or members may be able to utilize a vehicle via a reservation system, which will be explained further below. Each user may be charged a fee in a variety of methods, such as per time or per mile. Users may not need to own a private vehicle when utilizing a car sharing system.

A user may request a vehicle utilizing an application on their mobile phone, computer, or vehicle computing system (VCS). The application may require the user to input the time/date of the reservation, time period of the reservation, type of vehicle, amount willing to spend, credit card information, driver information, travel or route information, and vehicle requirements (e.g. type of vehicle, size, requirements, etc.). Furthermore, the location of the user requesting the vehicle, or the location of where the user may be when the vehicle is needed, may also be utilized to help request a vehicle.

The vehicle sharing system 201 may utilize data from the vehicle 203 to facilitate and optimize the vehicle sharing experience. For example, the vehicle 203 may utilize location data 209 to facilitate the vehicle sharing experience. Local data may include data identifying the location of the vehicle, location of a user in need of a vehicle, date and time that a user may be finished with a vehicle, data and time that a user may need the vehicle, etc. Data from other devices (e.g. nomadic devices) and applications may be utilized to facilitate in the process. For example, data utilized from social networking sites (e.g. Facebook, Twitter, etc.) may be utilized. Thus, a vehicle may be shared by a user that maintains a relationship with an acquaintance of a user. Furthermore, the

The vehicle sharing system 201 may also utilize vehicle data 215 to facilitate in the process, such as the vehicles identification number (VIN), key, door status, shifter status, odometer data (miles, maintenance), etc. Furthermore, data regarding the model/make of the vehicle, type of car (e.g. sedan, sports car, minivan, convertible, etc.), number of seats and seatbelts, cargo volume, trailer towing capabilities, vehicle performance data, vehicle options (e.g. navigation system, sound system, safety features (blind spot system, adaptive cruise control, airbags, etc.), wheel drive (4×4, rear-wheel drive, front-wheel drive, etc.), and other vehicle data may be utilized.

The vehicle sharing system 201 may also utilize user data 211 to facilitate in the process, such as driver or passenger identification. A user may select an option to enable user identification for the system to utilize that data and for other users of the vehicle sharing system 201 to use. The system or vehicle may identify a driver by numerous methods, including using the vehicle key fob, Bluetooth phone (e.g. when the phone is paired with the VCS), seat settings, voice recognition, biometric scanner, etc. Vehicle driving history and criminal background information may be also utilized to identify data to flag high/low risk drivers/users. Insurance information related to the user may also be utilized. A user or vehicle may also have an associated rating or review that includes any praises or critiques of that user or an associated vehicle.

The vehicle sharing system 201 may also utilize vehicle access control data 213 to facilitate in the car sharing process. The vehicle access control 213 may allow for an off-board server or another device to communicate with the vehicle to obtain the various data that may be shared. The vehicle access control data 213 may help determine availability and authentication of a user for a specific vehicle at a specific time.

Other vehicles 205 may also be in communication with the vehicle sharing system 201 to communicate with the local data 209, user data 211, vehicle access control 213, and vehicle data 215. The data from the other vehicles 205 may be utilized to help facilitate the vehicle sharing process. Vehicle probe data may also be utilized to help facilitate configuring the social-graph for output.

The vehicle 203 and vehicles 205 may be in communication with a server 227 via the internet/cloud 207. The vehicles may communicate all or some portion of the data collected to the cloud 207 to facilitate in processing, communication, and storage. The cloud 207 may be utilized to also utilize other data from other sources to facilitate in the vehicle sharing process. For example, the cloud 207 may utilize dynamic data as related to traffic, weather, events, banking/credit, criminal background/history, local demographic information, etc., to facilitate and to be utilized in the vehicle sharing process.

The server 227 may include the capability to offer a peer-to-peer (P2P) car sharing social-graph configurator 225. A social graph may help depict relationships between the various users and/or vehicles to facility in car sharing, among other things. The social-graph may indicate the relationship between the vehicle, the current driver, potential drivers, road-network, and potential meeting-spots within a community. The social graph configurator may utilize the various data, including vehicle access control 215, vehicle data 219, and local data 221, and user data 223 to help facilitate preparation of the social graph. Once the social-graph is created or updated, car sharing may be facilitated by offering recommended vehicles and locations. The social-graph configurator may be constantly updated to work dynamically. The social-graph may be output in a graphical format on a vehicle display, a nomadic device display, a message/email to a user, a display kiosk, etc. The social-graph may also manifest itself in the background where it may interact with other social network data to automatically suggest novel communities or new car sharing partners based on shared interests and mobility activities

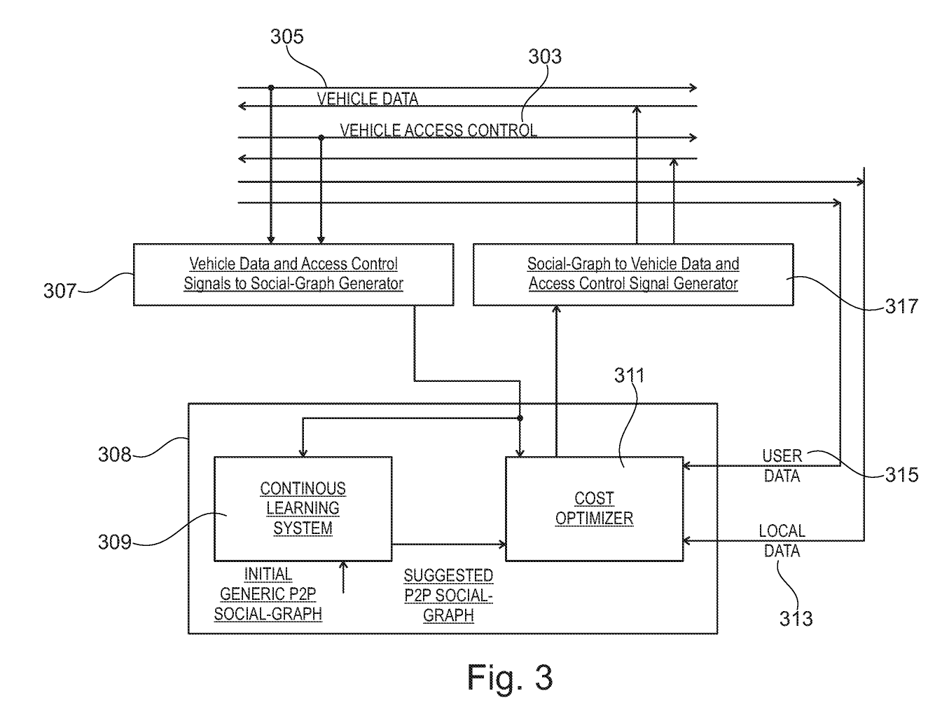

FIG. 3 is an example of the social-graph configurator utilizing various data to facilitate in the car sharing process. The vehicle access control 303 may include two-way communication between the vehicle and server 308 to communicate the vehicle access control data. The user data 309 and local data 307 may be fed into the p2p social-graph configurator to create a peer-to-peer(p2p) car-sharing social-graph. In one example, the social graph configurator may determine the user and receive location information utilizing the local data 313. This data may be utilized to output the initial car-sharing social-graph. The social graph may be output by a vehicle data and access control signal generator 317. When the user data of a vehicle updates/changes, and the local data updates/changes, a social-graph may be updated for the vehicle. The data flow of the vehicle sharing system may change based on the type of data used, such as the vehicle access control, vehicle data, local data, and user data. FIG. 3 includes a peer-to-peer car sharing social-graph configurator 301. One or more servers 308 may include a system for continuous learning 309 and a cost optimizer 311. A single server 308 may also include both the continuous learning system 309 and the cost optimizer 311.

The continuous learning system 309 may initially suggest a generic P2P social-graph for suggesting potential car-drivers. The generic P2P social-graph may use some initial attributes to output the initial social-graph, such as location, friend/acquaintance in a social network, and vehicle need. The continuous learning system may utilize the vehicle data 305 and vehicle access control data 303, as well for the initial social-graph generator, for the updated social-graphs.

Once a social-graph is suggested, the cost optimizer 311 may be utilized to help determine which users and nodes may be optimal for potential car-drivers. The optimizer may be based on other factors or data that is not considered by the continuous learning system, such as weather data and traffic data. However, the cost optimizer may also utilize information used by the continuous learning system. For example, the same or similar data may be utilized by both the cost optimizers and the continuous learning system. The cost optimizer may utilize or emphasize both user data 315 and local data 313 for cost optimization of the social graph. For example, the cost optimizer may utilize the number of nodes, locations of the nodes, the number of links, etc. for cost optimization. The cost optimizer may identify a non-active node to utilize and update the non-active node accordingly. The cost optimizer may use heuristic methods or mathematical programming methods to solve the optimization.

The cost optimizer may communicate an initial, personalized P2P social-graph configuration at the start of a rental/sharing period of a user. An interface to the social-graph to vehicle data and access control signal generator 317 may facilitate in the output of information or recommendations for a specific user or a vehicle For example, the social graph to vehicle interface 317 may to allow a specified user to obtain access to a specified vehicle for sharing/rental. The social-graph to vehicle data/access interface 317 may be located either off-board, at the vehicle (e.g. VCS), or at a nomadic device. The social-graph to vehicle interface 317 may facilitate in providing a recommendation or message based on the social graph. For example, the user may receive an alert or message notifying the user of an ideal user of the vehicle. In another example, a user may receive a notification of an ideal vehicle within the community. Furthermore, the social graph may be used to update the community (e.g. expand or compress the community) and recommended vehicles, as well as remove users and vehicles.

Additionally, the data flow for different data utilized in the social graph and cost optimizer may be either one-way or two-way. For example, the vehicle access control 303 may include bi-directional data flow that is communicated back-and-forth between the vehicle and the server. The server may receive data as related to the vehicle access control when rented versus when it is returned. The door lock/unlock may be local access only when returned or returned. Additionally, remote locking and unlocking may be enabled when rented, however, the vehicle or server may communicate any change in status (e.g. was it enabled or disabled) when the vehicle was returned. The vehicle access control data may also consider whether the engine start was enabled, engine remote start was enabled, setting a range limit on the vehicle (limit per day, week, month, etc.), a speed limit on the vehicle. The vehicle access control may also consider any change in the state for each of the attributes when the vehicle is returned.

The vehicle data may also be communicated in a bi-directional flow. For example, the vehicle may provide the fuel level of the vehicle when rented and when the vehicle was returned. The vehicle may also provide the location of the vehicle when rented and returned. The expected time of return and the actual time of return may also be utilized. The vehicle data may include the tire pressure when rented and returned.

The local data may be sent via one-way from a server to the vehicle. The local data may help with both the cost optimization and the social-graph. Some of the local data may include identifying certain bridge and tunnel crossings (identify delays), provide one-way streets, and congestion/traffic. Additionally, local event information may also be provided to notify the VCS of sporting events, cultural/city events, political events, and holiday events. Furthermore, weather data may be sent to indicate whether the weather may have an effect on the social-graph. For example, rain/snow, high-low temperature, advisory warnings, high winds, and other data. All of the local data may help facilitate ideal meeting points or nodes for vehicles and potential renters/drivers to meet.

User data may also be sent via one-way transmission from the vehicle to an off-board server. The user data may help with both the cost optimization and the social graphs, as well as help determine ideal meeting points for a vehicle and potential driver/renter. Some information that may be utilized is personally identifiable information (PII) data which includes but is not limited to, age, gender, disability, access needs, child-seat needs, etc. Additionally, the user data may also include Non-PII data, such as whether the user is alone or with friends/family, whether minors are in the vehicle or whether adults are in the vehicle, etc. Furthermore, the user data may include whether the vehicle is transporting only people, goods/products, or both. The user data may also identify whether the vehicle is being used for commuting, leisure, errands, commercial operation, etc. Other such user data may help facilitate the social graphs and cost optimization. While the current embodiment utilizes user data in a one-way transmission setting, other embodiments may transmit user data in two-way transmission to communicate between the vehicle and off-board server. For example, the vehicle may send an acknowledgement message (e.g. “received” or “received with noise, retransmit” or “error”) to the server.

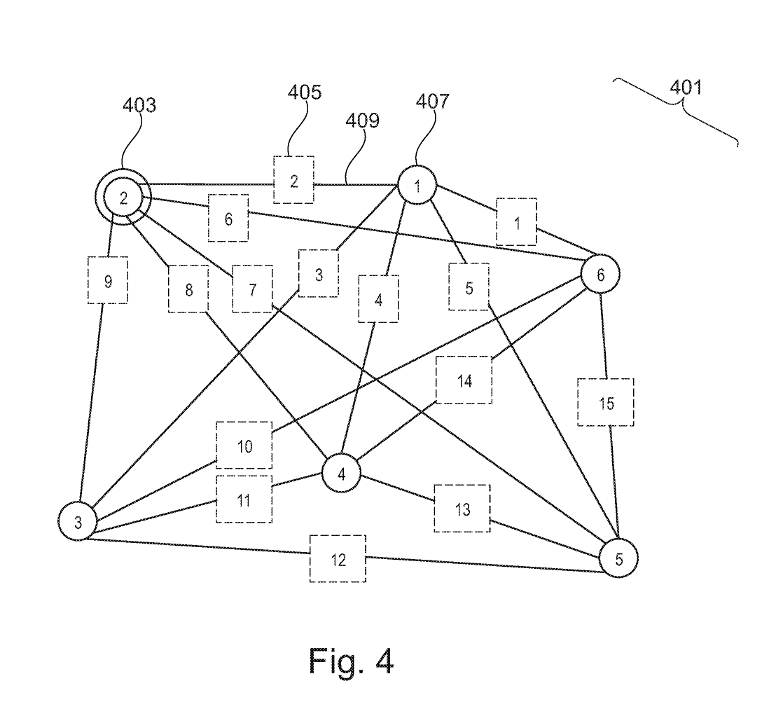

FIG. 4 is an example topology of P2P car sharing social graph 401. The social graph may identify potential car-drivers 407 (e.g. “peers” or “nodes”) at different locations and links (or “edges”) 409 between them. For example, the embodiment of FIG. 4 illustrates 6 potential car-drivers (one vehicle with driver 403) and 15 links 409 between them. There may be a very large number of paths by which a car-driver could reach each other to check-out/reserve a car from one of their peers or to check-in a car with one of their peers. More generally, this is a P2P car-sharing social graph defined by the number of drivers 407, the number of links 409, and number of paths.

The social-graph 401 may include various properties to help facilitate the car sharing experience. One example may include driver properties. The social graph can share credit rating, safety rating, reliability rating, maintenance rating, and other attributes. For example, if a user has a tendency to not pay, the credit rating may be displayed to warn vehicle owners. Each of the driver properties will be a factor and may be weighted dynamically and individually for the social graph.

In another example, the social graph may include properties related to the links or nodes. Links could arise from physical proximity, social networks (e.g., Facebook, Google+, Twitter, LinkedIn, etc.), historical communications (e.g., email, SMS, video chat, etc.), common membership in clubs, common membership in organizations, common membership and societies, family relationships, common employer, common workplace, links that are established primarily for forming a vehicle sharing community. For example, the social graph may note that some link properties may include whether the link is short or long, in an urban or rural area, directed (e.g. the driver is willing to travel to check out a car or driver expects to be brought home) or non-directed, as well as other link properties. Each of the link properties will be a factor and may be weighted dynamically and individually for the social graph.

In another example, the social graph may include path properties related to the path of travel or potential travel for a potential driver and the rental vehicle. For examples, the social graph may note that some path properties may include the congestion of the path, the safety of the path, the physical condition of the path, the lighting condition of the path, whether the path is in a public or private area, etc. Each of the path properties will be a factor and may be weighted dynamically and individually for the social graph.

In another example, the P2P car sharing social graph may be a closed community. The closed community may include one vehicle that may be associated with a vehicle ID #. While this example includes one vehicle, other embodiments may include multiple vehicles that are used within the community. The closed community may have several users within it. The users may each share the vehicle. The community may define a maximum number of users for the community. For example, the community may be limited to only 20 users based on the size of the closed community. The number of users may vary by community and may also be changed within a closed community to accommodate the need for a vehicle.

The closed community may also define the available parking spots that may be used for vehicle sharing. Parking spots may be determined based on the location of the vehicle and the other users in the community. Furthermore, factors regarding the road network or point-of-interest (POI) may be used to determine the location. For example, the social graph configurator may consider traffic data, road function class, neighborhood safety, one-way restrictions, hours of operation, toll/parking fees, and other factors when determining an ideal parking spot. Each community may include a max number of parking spots that may be plotted within the community by the social graph configurator.

Reservations and booking of a vehicle within a community may be accomplished by utilizing a vehicle computer system, a mobile/web-based booking system, or smart kiosks. Each of the reservation and booking systems may be either located within or the outside of the closed community. For example, chagrining stations may include a kiosk for reservation systems. A nomadic device, such as a mobile phone or tablet, may include an app to reserve a vehicle for car-sharing. Furthermore, restaurants (as well as other POI locations) may also include kiosks for car sharing.

The closed community may include a common set of rules that may be used within the community (e.g. the city, state, nation, or world). The rules may include etiquette or rules for the social graph, as well as a recommend practice within the community. While the rules may be utilized for the social graphs, exceptions may exist for the community. In alternative embodiments, the rules may be dynamic and change based on various factors (e.g. user-feedback, vehicle demand, etc.). Some examples of rules may include obeying all traffic & safety regulations, returning a vehicle with a specific threshold of fuel, maximum duration of continuous usage, maximum number of check-outs, minimum expectations of interior cleanliness (e.g. no trash inside); trunk (or “boot”) is clean; on time return; immediate notification if there is any physical damage or an accident; payment of all parking tickets, etc.

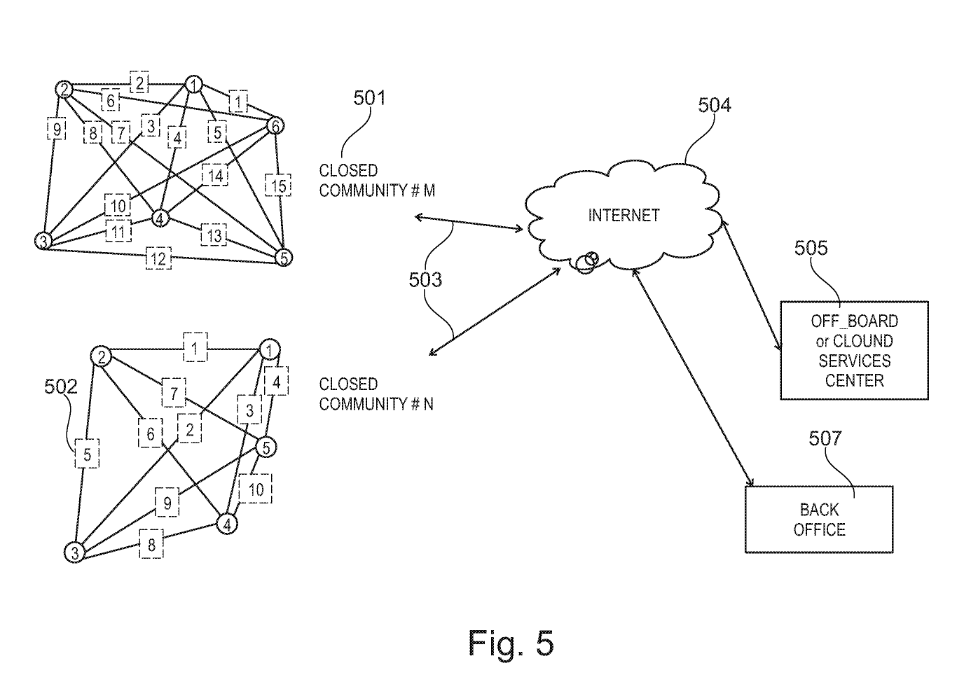

FIG. 5 illustrates an example of the peer-to-peer car sharing architecture. The architecture may include multiple closed communities, such as a closed community 501 representing one community, and another closed community 502 to represent another community. The community may be closed to limit participation of users from different communities, or for other reasons (e.g. exclusivity, to meet driver demand, shared destinations for daily commuting—such as close to work and home locations, meet a local workplace demand—such as pool-car usage at a common employer, etc.) As the communities may be closed, data may not be exchanged between communities directly. Additionally, users or vehicles may be part of only a certain community. Each community may be open to a city, neighborhood, apartment complex, IT park, certain area of the city, etc. Users may or may not be part of different communities.

The communities may transmit/receive data 503 to the cloud 504 to facilitate in the social-graph generation. The cloud 504 may then transmit data an off-board or cloud services center 505 or communicate with a back office 507. The back-end servers may utilize a web connection to communicate within the P2P car sharing architecture. While FIG. 5 indicates that the off-board services center 505 and the back office 507 are separate entities, other embodiments may include the same entity providing both types of services. The off-board server 505 may help process all the data to facilitate in the social-graph generation and cost optimization as explained above.

The back office 507 may help facilitate with the P2P car sharing architecture. The back office may include bill services and customer support. Additionally, engineering and research and development may be conducted in the back office. Additionally, business development could be conducted as well. Communication between the back-office 507 and the service center 505 may help facilitate user-complaints and evolve the social graph generator, as the service center 505 may tweak or change the social graph configurator and cost optimizer through efforts by the back-office 507.

The car-sharing may include fractional insurance to protect the vehicle. Various levels of insurance may be utilized. The reservation system and kiosk may allow the user to select the type of fractional insurance to utilize. Furthermore, the community may set rules to define a minimum type of fractional insurance. Fractional insurance may be defined differently for different vehicle-sharing scenarios. For example, the fractional insurance may be different for renting within a city and within the city. In another scenario, the fractional insurance may change for vehicle sharing that requires the vehicle to go from city-to-city, out-of-country, weekend rentals, holiday rentals, off-hours, and other scenarios. The social-graph configuration may include such insurance related information to provide recommendations for a type of insurance, insurance provider, prediction of part replacement, or maintenance information (e.g. recommended dealer, recommendation maintenance schedule, etc.).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A server comprising:
a transceiver configured to communicate data with a remote vehicle computer system and a car-reservation system; and
a processor configured to utilize the data to output a car-sharing social-graph, the car-sharing social-graph including graphical output depicting a vehicle for sharing, a vehicle-location, a user-location, and a potential parking-spot for sharing the vehicle.

2. The server of claim 1, wherein the data includes user data indicating information about a user within a car-sharing community.

3. The server of claim 1, wherein the data includes local data including information about the car-sharing community.

4. The server of claim 1, wherein the data includes vehicle-access control data indicating information about the availability of the vehicle.

5. The server of claim 4, wherein the processor is further configured to utilize the vehicle-access control data to authenticate a potential user of the vehicle.

6. The server of claim 1, wherein the data includes vehicle data indicating information about a vehicle.

7. The server of claim 1, wherein the social-graph outputs a recommendation for a vehicle drop-off location.

8. The server of claim 1, wherein the processor is further configured to utilize a cost-optimizer to update and identify a non-active node.

9. The server of claim 8, wherein the non-active node is a user of a car-sharing community.

10. The server of claim 1, wherein the social-graph includes a graphical display depicting a relationship between the vehicle and one or more users within a car-sharing community.

11. A vehicle computer system, comprising:
a transceiver configured to communicate data with a remote server including vehicle data, vehicle reservation data , and social-graph data from the remote server related to the vehicle and the vehicle reservation; and
a processor configured to utilize the data to authenticate a user and a vehicle after authenticating the vehicle reservation.

12. The vehicle computer system of claim 11, where in the data further includes user data indicating information about a user within a car-sharing community.

13. A method for car sharing, comprising:
communicating data with a remote vehicle computer system and a car-reservation system; and
outputting a car-sharing social-graph, the car-sharing social-graph including graphical output depicting a vehicle for sharing, a vehicle-location, a user-location, and a potential parking-spot for sharing the vehicle.

14. The method for car sharing of claim 13, wherein the data includes user data indicating information about a user within a car-sharing community.

15. The method for car sharing of claim 13, wherein the data includes local data including information about the car-sharing community.

16. The method for car sharing of claim 13, wherein the data includes vehicle-access control data indicating information about the availability of the vehicle.

17. The method for car sharing of claim 13, wherein the processor is further configured to utilize the vehicle-access control data to authenticate a potential user of the vehicle.

18. The method for car sharing of claim 13, wherein the data includes vehicle data indicating information about a vehicle.

19. The method for car sharing of claim 13, wherein the social-graph outputs a recommendation for a vehicle drop-off location.

20. The method for car sharing of claim 13, wherein the processor is further configured to utilize a cost-optimizer to update and identify a non-active node.
